(19) United States
(12) Patent Application Publication
(10) Pub. No.: US 2002/0055863 A1
(43) Pub. Date: May 9, 2002

(54) VIP reservation system

(76) Inventor: David Behaylo, Ferndale, MI (US)

Correspondence Address: John S. Artz, Ste. 250, 28333 Telegraph Road, Southfield, MI, 48304, US

(21) Appl. No.: 09/850,024

(22) Filed: May 7, 2001

Related U.S. Application Data
(60) Provisional application No. 60/246,825, filed on Nov. 8, 2000.

(51) Int. Cl. G06F 17/60

(52) U.S. Cl. 705/5; 705/15

(57) ABSTRACT

A reservation system 10 is provided including a reservation mechanism 22 accessible by one or more service providers 15 and customers 17. The service providers 15 open an account with the reservation mechanism 22. The reservation mechanism 22 relays service provider information to an advertising mechanism 24 and a ticketing mechanism 26. The advertising mechanism 24 provides a mechanism for one or more service providers 15 to promote their businesses. The ticketing mechanism 26 allows one or more customers 17 to purchase tickets for services offered by one or more of the service providers 15. A communication network 28 is provided which allows communication between the reservation mechanism 22, the advertising mechanism 24, the ticketing mechanism 26, and the customers 17.

### CROSS REFERENCE TO RELATED APPLICATIONS

The present invention claims priority from U.S. Provisional Application Ser. No. 60/246,825, filed Nov. 8, 2000, and entitled “Platinum VIP System”.

### TECHNICAL FIELD

The present invention relates generally to communication systems and more particularly, to a system and method for creating VIP reservations at various bars or nightclubs.

### BACKGROUND OF THE INVENTION

Currently, there are several problems that customers who would like to frequent a bar or nightclub encounter under the current process of entering a bar or nightclub: the customer must first determine which bar to visit. Thereafter, the customer has to take acts to visit the selected bar or nightclub and then the customer must physically enter and visit that particular bar or nightclub.

One problem with the above process is that most customers lack knowledge of available bars and information associated with each bar, which prevents the customer from forming an educated decision as to which bar to attend. Customers often venture to a bar and are disappointed once inside that bar. Deciding which bar to attend in combination with physically entering the bar can be a long enduring process especially during peak business hours.

Another problem customers encounter after deciding which bar to attend is that of waiting in long lines in order to enter. Many lines in which customers may have to wait are formed outside the bars in unprotected bad weather for a considerable amount of time. The customer after waiting in a long line and paying a cover charge or entry fee may determine his/her initial decision of which bar to visit was not correct, at which time the customer has the displeasing option of beginning the process all over again at another bar. The above stated process wastes customer time, money, and energy.

A major problem for a bar with the previously stated process is the continuous loss of potential customers and earnings. One source of lost earnings may be for the reason that some customers are deterred away from a bar because of the long lines. An additional source of lost earnings is the problem that customers that choose to wait in the long lines are not purchasing products or using the bar facilities while waiting in line. Furthermore, the bar may have many disinterested customers since they were unaware of the activities or events occurring inside the bar when they entered. For this reason the attitude of all the customers or guests of the bar are negatively effected, which thereby affects sales.

Another problem bars have with the current process is the lack of effective advertising to or educating of potential customers. Advertising, as is known in the art, is costly and is not always received in the most effective manner. Advertising by radio or by television is very costly and therefore usually avoided. Advertising by written materials or by word-of-mouth is normally only received by a small finite group of customers. Therefore, unfortunately, many potential interested customers are not targeted and enlightened with appropriate information about the bar.

Therefore, it is desirable to provide a process that reduces the amount of time wasted for both the bars and the customers. It is also desirable to provide a process for efficient use of bar or nightclub facilities. Increasing efficiency and using time productively increases the number of satisfied customers and directly increases profits and consumer responsiveness.

### SUMMARY OF THE INVENTION

The forgoing and other advantages are provided by a reservation system including a reservation mechanism accessible by one or more service providers and customers. The reservation system also includes an advertising mechanism and a ticketing mechanism. The advertising mechanism provides a mechanism for one or more service providers to promote their businesses. The ticketing mechanism allows one or more customers to purchase tickets for services offered by one or more of the service providers. A communication network is provided which allows communication between the reservation mechanism, the advertising mechanism, the ticketing mechanism, and the customers.

A reservation method is also provided including opening an account containing service provider information. The service provider information is communicated to the advertising mechanism and the ticketing mechanism. The reservation system educates customers with regards to the service provider information. The reservation system receives reservations from the customers pertaining to the service providers. The reservation system communicates the reservations to the service providers.

The present invention has several advantages for both bars or nightclubs and their customers. One advantage of the present invention is that it saves time for both the bars and the customers. The bars realize a more productive and efficient use of their facilities. The customers save time in determining which bar to visit and have the opportunity to avoid standing in long lines.

Another advantage of the present invention is that it better informs both the bars and the customers of available information. The bars have information pertaining to their customers and the customers have information pertaining to the bars. The bars have a better estimation of the number of customers that may respond for a particular evening and are able to better prepare for that evening. The customers have easy access to bar information and are therefore able to make educated decisions as to which bar to attend.

Yet another advantage of the present invention is that it increases earnings for the bars and saves money for the customers. The bars have more interested customers visiting their bars increasing sales of products and additionally possess a method of sharing the expense of advertising with other bars. The customers are better informed about each bar and thereby, avoid spending money at bars of no interest.

The present invention itself, together with further objects and attendant advantages, will be best understood by reference to the following detailed description, taken in conjunction with the accompanying drawing.

### BRIEF DESCRIPTION OF THE DRAWING

For a more complete understanding of this invention reference should now be had to the embodiments illustrated in greater detail in the accompanying figures and described below by way of example.

FIG. 1 is a block diagrammatic view of a reservation system in accordance with an embodiment of the present invention; and

FIG. 2 is a block diagrammatic view of a reservation system in accordance with an embodiment of the present invention.

FIG. 3 is a flow chart illustrating a reservation method according to the present invention.

### DETAILED DESCRIPTION OF THE PREFERRED EMBODIMENT

While the present invention is described with respect to a reservation system and method, the following reservation method is capable of being adapted for various purposes and is not limited to the following applications: bars, nightclubs, restaurants, parks, dance clubs, or other service industries.

In the following description, various operating parameters and components are described for one constructed embodiment. These specific parameters and components are included as examples and are not meant to be limiting.

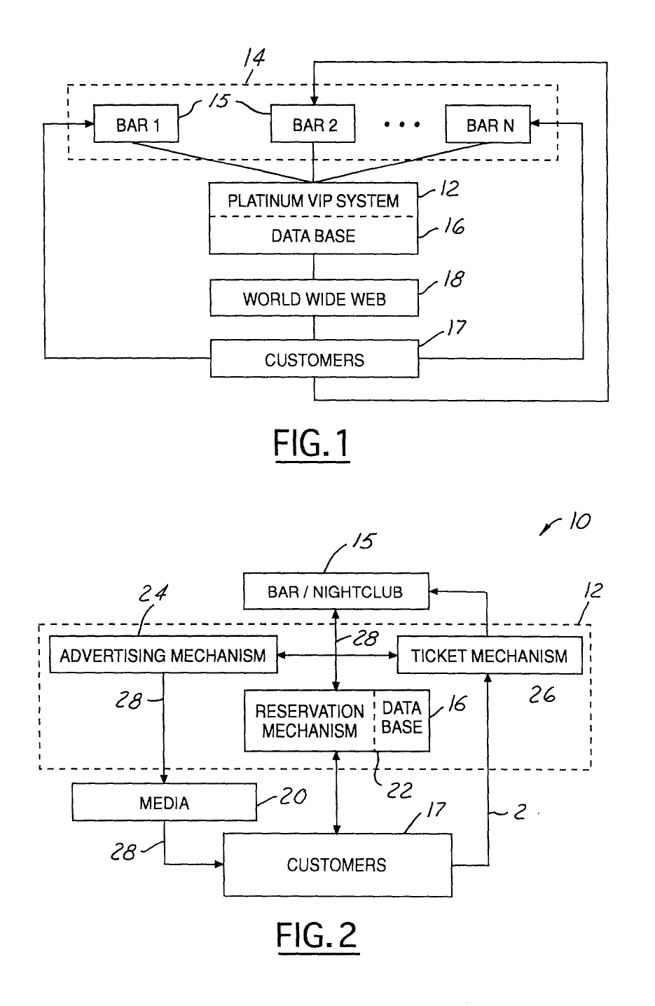

Referring now to FIG. 1, a block diagrammatic view of a reservation system 10 in accordance with an embodiment of the present invention is shown. The reservation system 10 includes a platinum very important person (VIP) system 12, which is in communication with a series of bars 14 containing a number of individual bars 15. The VIP system 12 receives bar information corresponding to each particular bar 15 and stores the bar information into a database 16 within the VIP system 12. The VIP system 12 also makes the bar information available to customers 17 via the world-wide-web (WWW) 18.

The bars 15 each have related bar or service provider information describing different features of their businesses including bar characteristics, bar facilities, methods of doing business, and other bar information. The bar characteristics may include but are not limited to the following: entertainment style, smoking or non-smoking, types of drinks or food, age requirements, hours of operation, capacity of customers or other related characteristics. The facility information may include but is not limited to the following: dance floors, restrooms, parking, square footage, number of floors and rooms, valet, or other facility related information. The methods of doing business may pertain to but is not limited to; types of customers, types of entertainers, different styles of advertising, different methods of payment, certain atmospheres, or other business methods. The bars 15 may also provide information related to VIP guest passes/tickets available for a given evening. Each bar 15 determines the number of VIP guest passes to offer as a percentage of bar capacity. For example if a bar decides to have 10% VIP guests and the bar capacity is 500 then 50 VIP passes are available for any given evening. Other various bar information may also be available, for example the bar location or names of related bars under the same owner. All of the above stated bar information using the reservation system 10 may be stored in the database 16. Although the present invention illustrates a series of bars 15 other service providers may be incorporated into the reservation system 10.

The VIP system 12 receives all the bar information that is available from the bars 15 and conveys the bar information to customers via the WWW 18 or other means. The VIP system 12 also provides an account in the database 16 for each bar 15 whereby all bar information is entered. The VIP system 12 may have certain criteria for bars 15 to satisfy in order to be registered or open an account in the VIP system 12. The VIP system 12 may rate the bars 15 using various rating methods as known in the art to provide customers 17 with a method of judging which bar 15 may be of interest to a particular customer. The VIP system 12 is continuously updated with new information and discards inappropriate information. The VIP system 12 organizes all the bar information and targets customers that would have interests corresponding to each bar 15.

The VIP system 12 also preferably enters VIP guest information into the database 16. Of course, information related to other customers may also be entered into the database 16. VIP guests are customers that have purchased VIP tickets. The VIP system 12 offers various services to both the bars 14 and the customers 17. Customers 17 may access the VIP system 12 and receive bar information. The bars 15 may also access the VIP system 12 and receive information on the VIP guests. VIP guest information may include but is not limited to the following: address, interests, number of reservations, recommendations, desired data of reservation, age, sex, and phone number.

The VIP system 12 offers advertising services to the bars 15. The bars 15 may pool funds for advertising using the VIP system 12. The VIP system 12 creates ad campaigns associated with each bar and advertises on the www 18. The VIP system 12 using the WWW 18 generates continued “awareness” about new and existing bars 15 participating in the VIP system 12 to potential new and existing customers 17. By continuously advertising on the WWW 18 and updating bar information in the database 16, the present invention provides competition between bars 15, which increases incentives and lowers costs for consumers 17.

The VIP system 12 also provides ticketing related services to both the bars 15 and the customers 17. The VIP system 12 provides a method of payment from the customers 17 for VIP tickets and distributes a percentage of the funds received to the bars registered in the VIP system 12. The remaining funds are used for the VIP system services. The VIP tickets provide purchasing customers with direct entry into a bar 15 within the series of bars 14 and a reserved “spot” within that particular bar 15. The VIP tickets may also provide additional benefits or incentives including discounts on parking, beverages, and food.

Although the WWW 18 is illustrated as separate from the VIP system 12, the WWW 18 may be incorporated into the VIP system 12. The VIP system 12 uses the WWW 18 in providing advertising services. The VIP system 12 may also use one of the following: radio ads, television ads, or other methods of advertisement known in the art to advertise bar information. The WWW 18 is accessed using a communication device that has access to an Internet connection. The following is a non-inclusive list of possible communication devices: the Internet, a computer system, a telephone network, a wireless communication network, a radio, a television, a mobile telecommunication system, a personal digital assistant, and a data network. The VIP system 12 is accessible via the WWW 18 for both the bars 15 and the customers 17.

Customers 17 have certain characteristics, desires, and interests. Customers 17 may prefer a bar 15 that provides certain types of music, food, drink, atmosphere, parking, or other features associated with a bar 15. The customers 17, using the present invention, have the ability to research bars 15 and determine which bar 15 has the features that correspond to the customer's interests using the VIP system 12. Using the VIP system 12, customers 17 also have the opportunity to ask questions “on-line” about specific bars 15 or enter constructive suggestions for future improvements. The customers 17 by using the VIP system 12, avoid standing in long lines, avoid standing in bad weather while waiting to enter a bar 15, purchase VIP tickets in the luxury, comfort, and convenience of the customer's home, and reserve a “spot” at a particular bar for an evening of the customer's interest.

Referring now to FIG. 2, a block diagrammatic view of the reservation system 10 in accordance with an embodiment of the present invention is shown. The reservation system 10 includes the platinum VIP system 12, a media 20, and the customers 17. The VIP system 12 includes a reservation mechanism 22, an advertising mechanism 24, and a ticketing mechanism 26. Although, the reservation mechanism 22, the advertising mechanism 24, and the ticketing mechanism 26 of the present invention are provided by separate entities they may be incorporated into a single system or business. The advertising mechanism 22 uses media 20 to relay bar information to the customers 17. The customers 17 purchase VIP tickets through the ticketing mechanism 26. The reservation mechanism 22, the advertising mechanism 24, the ticketing mechanism 26, the media 20, and the customers 17 communicate to each other via a communication network 28.

The reservation mechanism 22 provides services to bars 15 including receiving and organizing all the bar information. The reservation mechanism 22 relays the bar information to the advertising mechanism 24 and the ticketing mechanism 26. The reservation mechanism 22 manages funds transferred between customers 17, the VIP system 12, and the bars 15. The reservation mechanism 22 contains a database of bar information including: addresses, phone numbers, hours of operation, upcoming and current events, special offerings, sales, characteristics, facility specifics, number of customers, availability, common asked questions, and methods of business.

The advertising mechanism 24 educates or informs customers 17 about bar information located within the VIP system 12. The advertising mechanism 24 uses the media 20 to inform customers 17 of the bar information. The present invention preferably uses the WWW 18 as media 20, which is accessible using an Internet connection, to inform customers 17. The advertising mechanism 24 may also use other available forms of advertising including newspaper and magazine ads and articles, radio commercials, television commercials, personal digital assistants, computers, data networks, mobile communication networks, or other forms of advertising known in the art. The advertising mechanism 24 also provides and develops ad campaigns for bars 15. The ad campaigns correspond to bar information of each bar 15. The ad campaigns therefore target specific customer groups that may be interested in a particular type of bar 15.

The ticketing mechanism 26 provides methods by which customers are able to purchase VIP tickets. The methods may be of various form including: electronic form, barcode form, and other ticket forms known in the art. The VIP tickets are distinguishable in that they correspond to certain times, days, events, bars, and other pertinent information for entering a bar 15 on a particular evening. The VIP guests may be provided with special identification devices and accounts. The ticketing mechanism 26 may accept various methods of payment including: check, credit card, cash, or other electronic or physical forms of payment. The ticketing mechanism 26 also provides immediate feedback to the bars 15 reflecting the number of VIP tickets sold. The immediate feedback allows bars 15 to have VIP guest information beforehand and prepare for any particular evening. The number of VIP tickets sold for a given evening may allow a bar 15 to make a better-informed estimate of the number of total guests that may arrive on a particular evening.

The communication network 28 used in the present invention is the Internet. The communication network is used to transfer bar information and VIP guest information between the reservation mechanism 22, the advertising mechanism 24, the ticketing mechanism 26, and the customers 17. The communication network may be a satellite communication system, a computer related system, a radio service, a telephone network, a mobile telecommunication system, a wireless communication network, or other terrestrial communication applications.

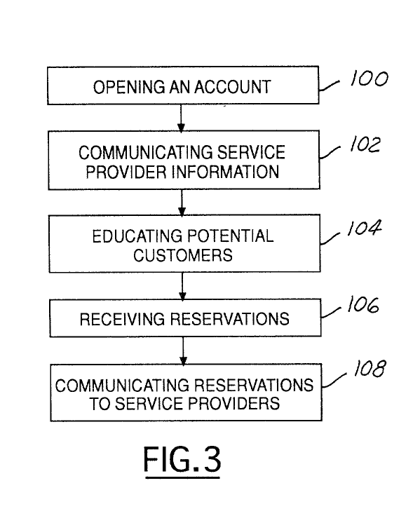

FIG. 3 is a flow chart illustrating a reservation method according to the present invention. In step 100, a bar 15 opens an account with the platinum VIP system 12. The reservation mechanism 22 receives bar/service provider information and enters the bar information into a data base 16 located within the VIP system 12. In step 102, the bar information is communicated to the advertising mechanism 24 and the ticketing mechanism 26.

In step 104, the advertising mechanism 24 using the media 20 informs customers of bar information entered in the database 16. In step 106, the ticketing mechanism 26 receives reservations from customers 17. In step 108, the ticketing mechanism 26 immediately communicates the number of reservations received to the bars 15. The ticketing mechanism 26 also transfers VIP guest information to both the bars 15 and the reservation mechanism 22.

The above-described invention, saves time for both bars and customers. The present invention also increases income for the bars and saves money for the customers. Moreover, the present invention also provides bars and customers easy access to information that is relative to each other, which is not normally readily available.

The above-described reservation system, to one skilled in the art, is capable of being adapted for various purposes and is not limited to the following applications: bars, nightclubs, restaurants, parks, dance clubs, or other service industries. The above-described invention may also be varied without deviating from the true scope of the invention.

What is claimed is:

1. A reservation system comprising:
a reservation mechanism accessible by one or more service providers and customers;
an advertising mechanism allowing one or more of said service providers to promote their business;
a ticketing mechanism allowing one or more of said customers to purchase tickets for services offered by one or more of said service providers; and
a communication network allowing communication between said reservation mechanism, said advertising mechanism, said ticketing mechanism, and said customers.

2. A system as in claim 1 wherein said reservation mechanism, said advertising mechanism, and said ticketing mechanism are incorporated into one or more entities.

3. A system as in claim 1 wherein said reservation mechanism further comprises a data base containing service provider information selected from the following group comprising: addresses, phone numbers, hours of operation, upcoming and current events, special offerings, sales, characteristics, facility specifics, number of customers, availability, common asked questions, and methods of business.

4. A system as in claim 3 wherein said data base further comprises VIP guest information selected from the following group: address, interests, number of reservations, recommendations, desired data of reservation, age, sex, and phone number.

5. A system as in claim 1 wherein said reservation mechanism provides special identification devices for VIP guests.

6. A system as in claim 1 wherein said advertising mechanism is selected from the following group comprising: an Internet site, a newspaper, a magazine, a radio commercial, and a television commercial.

7. A system as in claim 1 wherein said ticketing mechanism allows a method of payment from said customers for VIP tickets.

8. A system as in claim 1 wherein said ticketing mechanism provides immediate feedback of reservations to said service providers.

9. A system as in claim 1 wherein said communication network is selected from the following group comprising: a world-wide-web (WWW), a computer related system, a radio service, a telephone network, a mobile communication network, and a wireless communication network.

10. A reservation method comprising:
opening an account containing service provider information;
communicating said service provider information to a ticketing mechanism and an advertising mechanism;
educating potential customers with regards to said service provider information;
receiving reservations from customers pertaining to said service provider; and
communicating said reservations to said service provider.

11. A method as in claim 10 wherein said opening an account further comprises:
receiving said service provider information; and
entering said service provider information into a database.

12. A method as in claim 10 wherein educating customers comprises advertising said service provider information to target customers.

13. A method as in claim 12 wherein advertising said service provider information comprises advertising said service provider information using media selected from the following group comprising: internet, radio, television, mobile telecommunications, personal digital assistants, computers, and data networks.

14. A method as in claim 12 wherein advertising said service provider information comprises developing ad campaigns.

15. A method as in claim 14 further comprising developing ad campaigns corresponding to different service provider information.

16. A method as in claim 10 wherein receiving reservations comprises entering VIP guest information into a database.

17. A method as in claim 10 wherein communicating said reservations to said service provider further comprises:
communicating said VIP guest information to one or more of said service providers; and
communicating the number of received reservations to one or more of said service providers.

18. A method as in claim 17 wherein communicating said VIP guest information comprises communicating VIP guest information selected from the following group comprising: address, interests, number of reservations, recommendations, desired data of reservation, age, sex, and phone number.

19. A VIP reservation system comprising:
a data base comprising service provider information;
a reservation mechanism accessible by one or more service providers and customers, said reservation mechanism providing said service providers and said customers access to said data base;
a media for advertising said service provider information;
an advertising mechanism allowing one or more of said service providers to promote their business via said media;
a ticketing mechanism allowing one or more of said customers to purchase tickets for services offered by one or more of said service providers; and
a communication network allowing communication between said reservation mechanism, said advertising mechanism, said ticketing mechanism, and said customers.

20. A system as in claim 19 wherein said database further comprises customer information.
